(19) United States
(12) Patent Application Publication
(10) Pub. No.: US 2013/0042043 A1
(43) Pub. Date: Feb. 14, 2013

(54) Method and Apparatus for Dynamic Channel Access and Loading in Multichannel DMA

(71) Applicants: Guanghui Zhang, San Jose, CA (US); Muralidhar Krishnamoorthy, San Diego, CA (US); Tomer Rafael Ben-Chen, Santa Clara, CA (US); Srinivas Maddali, Bangalore (IN)

(72) Inventors: Guanghui Zhang, San Jose, CA (US); Muralidhar Krishnamoorthy, San Diego, CA (US); Tomer Rafael Ben-Chen, Santa Clara, CA (US); Srinivas Maddali, Bangalore (IN)

(73) Assignee: QUALCOMM INCORPORATED, San Diego, CA (US)

(21) Appl. No.: 13/204,883

(22) Filed: Aug. 8, 2011

(51) Int. Cl. G06F 13/28

(52) U.S. Cl. 710/308

(57) ABSTRACT

An arbiter detects waiting states of N buffers holding direct memory access (DMA) requests, and detects an availability of R core channels of a core R-channel DMA memory. The arbiter, based on the detection, dynamically grants up to R of the N buffers access to the R core channels. An N-to-R controller communicates DMA requests from the N buffers to currently granted ones of the R core channels, and maintains a location record of different data from each of the N buffers being written into different ones of the R core channels.

### FIELD OF DISCLOSURE

The embodiments pertain to data memory management and, more particularly, to management of multi-channel access to data memory.

### BACKGROUND

Direct Memory Access (DMA) memory generally refers to a memory independently accessible by one or more main processors and each of a plurality of separate access-requesting entities (hereinafter referenced as “peripheral devices”), without requiring intervention by the main processor(s). DMA memory having a plurality of channels for independent access by different peripheral devices may be termed a “multi-channel” DMA memory. Uses of DMA memory include reducing load on a main processor that would otherwise result it having to directly control receipt and storage into memory of what may be large blocks of data sent by various peripheral devices.

Systems using multi-channel DMA memory may have assignment limits of only one peripheral device to each of the multiple DMA channels. This inherently limits the number of peripheral devices that current conventional multi-channel DMA memory can service—to the number of channels possessed by that DMA memory. If an increase from an R-channel DMA to an N-channel DMA is needed, an only solution may be total replacement of the R-channel DMA system memory with a new N-channel DMA system memory. Such replacement generally carries substantial costs, e.g., design, fabrication, and test of new DMA integrated circuits (ICs), and of new and/or upgraded DMA support hardware, as well as software and system test capabilities. These costs can place a significant cost barrier against increasing the number of peripheral devices that conventional multi-channel DMA system memory can service.

Further, conventional multi-channel DMA memory is generally designed so to provide each of the channels with the same bandwidth (BW). Example reasons include inventory cost and device interchangeability. However, because various different peripheral devices, having correspondingly different peripheral device BW requirements, may couple to any of the DMA channels, all must have a bandwidth capacity meeting the highest of these different BW requirements. As a result, except in what may be rare instances of all peripheral devices exhibiting the same, constant use of memory BW, many of the channels of conventional multi-channel DMA memory are under-utilized.

Related to the above inefficiency of some channels of a conventional N-channel DMA memory being under-utilized, there is limited, if any means in conventional N-channel DMA memory to shift unused capacity of one channel to relieve an overloaded channel. As a result, during the operation of a current multi-channel DMA memory, a frequent condition is that some of the peripheral devices experience back-up or delay in executing processes, while unused BW sits idly on other channels.

### SUMMARY

One embodiment includes an N-channel direct memory access (DMA) memory, having a core memory with R core DMA channels, and N DMA command buffers, N being greater than R. In one aspect an N to R arbiter detects DMA requests in the DMA command buffers, and a DMA channel status indicator identifies available DMA channels among the R core DMA channels. In one aspect the N to R arbiter assigns detected DMA requests in the DMA command buffers to the available core DMA channels.

In an aspect, an N-channel DMA memory according to one embodiment includes a DMA channel status indicator having a core channel status array storing, for each corresponding one of the R core DMA channels, a value indicating an availability of the core DMA channel.

In another aspect, an N-channel DMA memory according to one embodiment includes having a core channel status stack for holding a stack of up DMA channel identifiers, each DMA channel identifier in the stack identifying an available core DMA channel.

One embodiment provides a method for N-channel DMA storage, the method including detecting a reception of DMA requests at each of N DMA input/output (I/O) channels, identifying an availability of core DMA channels among R core DMA channels, R being less than N, and assigning detected received DMA requests to core DMA channels indentified as available.

One embodiment provides an N-channel DMA storage having means for detecting reception of DMA requests at each of N DMA input/outputs, means for identifying an availability of core DMA channels among R core DMA channels, R being less than N, and means for assigning detected received DMA requests to core DMA channels indentified as available.

### BRIEF DESCRIPTION OF THE DRAWINGS

The accompanying drawings are presented to aid in the description of embodiments of the invention and are provided solely for illustration of the embodiments and not limitation thereof.

FIG. 1 is a functional block diagram of one example N-channel DMA memory according to one exemplary embodiment.

FIG. 2 is a functional flow diagram of one example N-channel DMA memory process according to one exemplary embodiment.

FIG. 3 is a functional flow diagram of one example N-channel DMA memory process according to one example alternative embodiment, including one example push-pop stack management of core channels.

FIG. 4 is a functional flow diagram of one push-pop stack management of core channels according to various exemplary embodiments.

FIG. 5 is a functional block diagram of one example personal computing device according to one or more exemplary embodiments.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof It will also be understood that the term “logic path,” in the context of a logic path from “A” to “B” means a defined causal relation, of any kind, direct or indirect, between A and B.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Various embodiments provide an N-channel dynamic tunnel DMA memory system having N individual DMA I/O buffers, each capable of communicating core memory access requests with a peripheral device, and a core R-channel DMA memory, where R may be smaller, by integer proportions, than N. In one aspect an N-channel dynamic tunnel DMA memory system according to the various embodiments includes an N-channel to R-channel (hereinafter “N:R channel”) arbiter to adaptively establish different patterns of “tunnels” from the N SMA I/O buffers to the R-channel core DMA memory. In one further aspect, each tunnel may be a logic path from one of the N DMA I/O buffers holding an access request command waiting to be serviced to an available channel of the core R-channel DMA memory. It will be understood that “tunnel,” for purposes of this disclosure, references a logic path from any one of the N DMA I/O buffers to any one the R channels of the core R-channel DMA memory, and carries no definition as to structure or means by which the logic path operates. In one aspect, the N:R channel arbiter may monitor the requesting status of the N DMA I/O buffers to identify which of the DMA I/O buffers is holding DMA requests waiting to be serviced. In one aspect, to provide the N DMA I/O buffers access to the R-channel core DMA memory through the adaptive pattern of tunnels, the N:R channel arbiter may maintain and continuously update an indicator of which of the R channels of the core R-channel DMA memory is (are) available and which are not available.

Since N, the number of DMA I/O buffers, can be greater than the number of core DMA channels, the N:R channel arbiter may detect instances where the number of DMA I/O buffers waiting with DMA requests not yet serviced is larger than the number of available core channels. In an aspect an N:R channel arbiter may be configured to respond to such instances. In one aspect an N:R channel arbiter may assign the N DMA I/O buffers to the R core channels as they become available, on a first-come-first-served (FCFS) basis. In another aspect, an N:R channel arbiter may be configured to respond, in instances of no presently available core channel, by assigning N DMA I/O buffers to the R core channels on, for example, a round-robin type of arbitration. It will be understood that these example configurations are not limiting, as persons of ordinary skill in the art may identify other schemes in view of this disclosure. It will also be understood that various N-channel DTA/DM memories and methods according to the exemplary embodiments may be practiced without having a capability to arbitrate N channel access in instances of no presently available core channel.

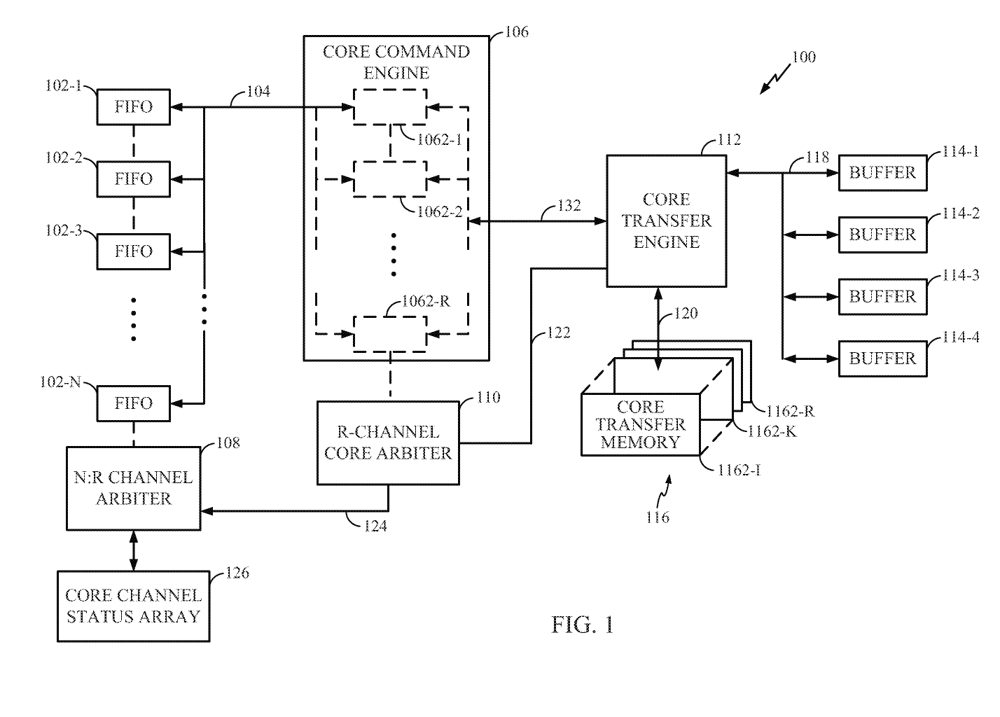

FIG. 1 is a functional block diagram of one example N-channel dynamic tunnel access DMA memory system (hereinafter “N-channel DTA/DM memory”) 100 according to one exemplary embodiment. The N-channel DTA/DM memory 100 includes N channel command FIFOs 102-1, 102-2 . . . 102-N (collectively “102”), and each may hold a stack of memory access commands, the memory access commands generically referenced as “AC”. It will be understood that “FIFO” is meant as a function, not as any particular hardware or specific protocol. Further, it will be understood that FIFOs are only one example kind of I/O buffer that may be used for N-channel I/O in practicing the exemplary embodiments. For example, DMA memory systems and methods according to the exemplary embodiments may be practiced with I/O buffers that are only one AC deep.

Referring still to FIG. 1, a DM input command bus 104 couples the N channel command FIFOs 102 to an R-channel core command engine (RCE) 106. As previously described, the value of R may be less than N. As one example, R and N may be 16 and 32, respectively. As another example, R and N may be 8 and 32, respectively. An N:R channel arbiter 108 controls assigning the N FIFOs 102 to the R core channel, in other words maintaining a changing pattern of tunnels from the N FIFOs to R core channels. The RCE 106 may have an internal memory having R memory spaces or regions, such as represented by the R core command regions 1062-1, 1062-2 . . . 1062-R, (referenced collectively as “1062”). Each of the R core command regions 1062 may correspond to one of the R core channels and each of the core command regions 1062 may hold one or more ACs associated with the channel. For brevity, the term “core channel” will hereinafter refer to any single core channel region 1062-x of the RCE 106, together with the resources of the RCE 106 and core transfer engine 112 in servicing ACs stored in the region. For convenience, these core channels will be referenced individually as core channel_r, for r=1 to R.

Referring still to FIG. 1, an R-channel core arbiter 110 may monitor the status of the R core command regions 1062, with respect to having ACs being executed or awaiting exccution, i.e., busy, as opposed to being empty, i.e., available. The R-channel core arbiter 110 may provide the R core command regions 1062 (and thus their AC commands) a one-channel-at-a-time access, for example, according to conventional arbitration schemes.

When access is given to a core command region 1062, one or both of the RCE 106 and the R-channel core arbiter 110 may read its stored AC and transfer the AC to the core transfer engine 112. The core transfer engine 112 may then perform the task specified by the AC. One example task specified by an AC may be a transfer of data blocks among data buffers such as among the example data buffers 114-1, 114-2, 114-3 and 114-4 (collectively “114”). This is only for illustration, as there is no limitation specific to the embodiments as to memory access instructions the core transfer engine 112 may be configured to perform.

In one aspect a core transfer memory 116 may be included for use by the core transfer engine 112. The core transfer memory 116 may have a separate section, or memory space, for each of the R core channels, such as provided by the depicted R transfer memory areas 1162-1 . . . 1162-R (collectively “1162”). The core transfer engine 112 may be configured to utilize the core transfer memory 116, for example in performing the above-described example of transferring blocks of data among the data buffers 114. To illustrate, the core transfer engine 112 may first retrieve the specified data block, or one of the data blocks, from the specified one of the data buffers 114 through a data transfer bus such as 118. The core transfer engine 112 may then load the data block, for example over a core transfer bus such as 120, into the particular core transfer memory area 1162 allocated to the core channel associated with the transfer instruction. The core transfer engine 112 may then retrieve the data block from that transfer memory area and load it, via the data transfer bus 118, into the specified destination data buffer 114.

When the core transfer engine 112 completes the task instructed by the AC, it may send an indication of “task complete” to one or both of the RCE 106 and the R-channel core arbiter 110. The task complete indication may, for example, be through the logical path 122. One or both of the R-channel core arbiter 110 and the RCE 106 may, in response, erase the AC associated with the task completed. Then, one or both of the R-channel core arbiter 110 and the RCE 106 may determine if the region 1062 having the just-erased AC is empty and, if so, may send a channel available (CA) message to the N:R channel arbiter 108, as shown by logical path 124.

Referring still to FIG. 1, in the exemplary embodiments the N:R channel arbiter 108 may, upon each detecting of an AC in the N channel command FIFOs 102, assign the AC to available ones of the R core channels. In one aspect, the N:R channel arbiter 108 maintains a core channel status array 126 of R individual core channel status (CCS) flags, which may be individually referenced as, for example, CCS-1 CCS-R (not shown the figures), each CCS flag indicating or having at least a busy state and an available state. Further to this aspect, associated with each reception by the N:R channel arbiter 108 of a CA message on 124 the N:R channel arbiter 108 may switch the corresponding CCS flag in the core channel status array 126 to show availability. Likewise, each time the N:R channel arbiter 108 assigns an AC from a channel command FIFO 102 to an available core channel, it may switch the CCS flag of the assignee core channel to a busy state.

With respect to priority given to each of the N channels, the arbitration performed by the N:R channel arbiter 108, in one aspect, gives all N channels equal priority. This is only one example and does not limit the scope of any embodiment, or any aspect. For example, the N:R channel arbiter 108 may be configured to give different priority to different ones of the N channel command FIFOs 102. In another aspect the N:R channel arbiter 108 may be configured to detect priority values in priority fields (not shown in the figures) according to a protocol of the AC instructions.

Referring still to FIG. 1, when the N:R channel arbiter 108 detects an AC at one of the channel command FIFOs 102 and at least one of the R core channels is available, the N:R channel arbiter 108 assigns that channel command FIFO 102 to an available one of the R core channels. Next, through action controlled by the N:R channel arbiter 108, or the RCE 106, or both in co-operation, the detected AC is loaded into the open region 1062-x in the RCE 106 that corresponds to the assigned channel. Since there are R core channels, x may be any value from 1 to R.

One illustrative servicing of an example AC, which will be termed “ACx,” from a particular j^{th} one of the N channel command FIFOs 102, referenced as 102-j, will now be described. This illustrative servicing assumes that one more of the R core channels are available. It is also assumed for this example that ACx is a request to move a specified block of data from the data buffer 114-2 to the data buffer 114-4. The data buffer 114-2 may be the “source” buffer 114 and the data buffer 114-4 may be the “destination” data buffer 114.

Continuing with the ACx example, first the N:R channel arbiter 108 detects ACx in the channel command FIFO 102-j, “j” being an arbitrary value for purposes of this description. Persons of ordinary skill in the art can readily select and implement, in view of this disclosure, various means for performing such detection and, therefore, further detailed description is omitted. The N:R channel arbiter 108 then, according to one aspect, checks the core channel status array 126 to determine if any of the CCS flags, CCS-1 CCS-R, indicates availability. In one aspect the checking may be a sequential read of the R flag locations in the core channel status array 126. In another aspect the core channel status array 126 may have, for example, a register or equivalent structure enabling concurrent reading of all R of the CCS flags. These are only examples, and are not intended as any limitation on the scope of means and methods for maintaining or checking the core channel status array 126.

Continuing with this illustrative servicing of ACx, it will be assumed that the CCS-k flag indicates availability, and that the identified available core channel will be the k^{th} core channel, core channel_k, where k is arbitrary and may be any value from 1 to R. After core channel_k is identified as available, the CCS-k flag is set to a busy state. Then, any one or more of the N:R channel arbiter 108, RCE 106 and/or a co-operative operation of both, may control a loading of ACx into the command region 1062-k associated with core channel_k. Next, in one example, the R-channel core arbiter 110, the core transfer engine 112 or both in co-operation read ACx from the core channel region 1062-k and transfer ACx over, for example, the core internal transfer instruction bus 132, to the core transfer engine 112. In one example, the core transfer engine 112 decodes ACx to be, as previously described, an instruction to move a specified block of data from the source data buffer 114-2 to the destination data buffer 114-4.

The core transfer engine 112, after this decoding of ACx, may execute an appropriate read from the source data buffer 114-2 via, for example, the data buffer transfer bus 118. In one aspect, the core transfer engine 112, after receiving the resulting read data, may temporarily store the read data in the core transfer memory 116, as previously described. For describing the example servicing of ACx, it will be assumed that the data block is stored in the core transfer memory region 1262-k, where “k” simply identifies that the core transfer memory region 1262-k corresponds, in this example, with the core channel 1062-k having ACx. The core transfer engine 112 may subsequently retrieve the read data from the core transfer memory region 1262-k and then may control, directly or indirectly, writing of the data into the destination data buffer 114-4. It will be understood that, depending on the size of the data block ACx requested moved relative to a capacity of the core transfer memory region 1262-k, the core transfer engine 112 may repeat the above-described sequence until the transfer is complete.

Continuing with the example servicing of ACx, as previously described the transfer engine 112 may be configured to detect completion of ACs, and upon such detection send a task complete notification, for example over logical path 122, to the R-channel core arbiter 110. In response, one of the R-channel core arbiter 110 and the RCE 106, or both in a co-operative operation, may erase ACx from the core channel region 1062-k. In one aspect, each core channel region 1062 may hold only one AC. Further to this aspect, associated with erasing ACx from the core channel region 1062-k, the R-channel core arbiter 110 may send the N:R channel arbiter 108 a corresponding “channel available” message over the logical path 124 indicating core channel_k is available. In response, the N:R channel arbiter 108 may set the CCS-k flag in the core channel status array 126 to indicate that core channel_k is available.

To avoid unnecessary complexities not relevant to the understanding of the concepts, specific description is omitted as to an N-channel DTA/DM memory 100 providing for one command channel FIFO 102 to interrupt an ongoing servicing of an AC of another of the command channel FIFOs. However, it will be understood that this is not intended to limit embodiments from including such a capability. Further, it will be understood that persons of ordinary skill in the art, upon viewing this disclosure, can readily adapt the concepts to practice the exemplary embodiments with an N-channel DM system providing for such interrupt.

It will be understood that the FIG. 1 example N-channel DTA/DM memory 100 is depicted as separate blocks, for example, the channel command FIFOs 102, N:R channel arbiter 108, RCE 106, R-channel core arbiter 110, and the core channel status array 126, arranged for graphical clarity to assist in describing example operations and interfaces, but that the blocks, their relative size and arrangement are not necessarily representative of any particular hardware architecture, or segmentation of functions with respect to hardware.

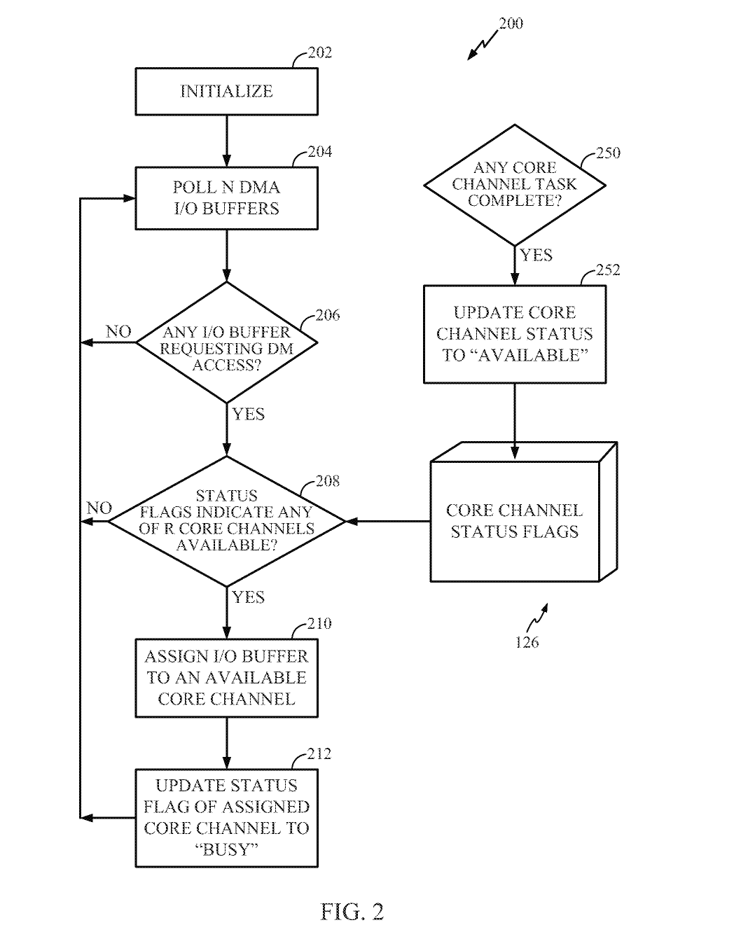

FIG. 2 shows a logic flow diagram of one example process 200 for carrying out one method according to one or more exemplary embodiments. Illustrative operations of processes according to the FIG. 2 logical flow diagram 200 are described in reference to the FIG. 1 example N-channel DTA/DM memory 100. However, this is not intended to limit the scope of any of the embodiments. On the contrary, various equivalent and alternative system arrangements for practicing the exemplary embodiments will become apparent to persons of ordinary skill from this disclosure.

Referring now to FIG. 2, the example process 200 may begin at an initialization 202. The initialization at 202 may, for example, set all R of the CCS flags in the core channel status array 126 to indicate the corresponding core channel as available. This is only one example, and various alternative initialization operations at 202 may depend, in part, on the particular hardware arrangement on which the example process 200 is practiced. Next, the process goes to 204 where it polls the N-channel I/O (e.g., the channel command FIFOs 102) to identify their status, for example whether they have ACs to be serviced. The polling at 204 may be performed by the N:R channel arbiter 108. In one aspect, as previously described, each of the channel command FIFOs 102 may be configured to indicate an access request waiting and an empty status. Persons of ordinary skill in the art can readily select and implement, in view of this disclosure, various means and methods for such polling and, therefore, further detailed description is omitted.

With continuing reference to FIG. 2, after the polling at block 204 the process 200 may go to a logical decision block 206 that routes the process depending on whether the polling at 204 identified any channel command FIFOs 102 having an AC to be serviced. If the polling at 204 identified no channel command FIFOs 102 having an AC to be serviced, the process 200 returns to 204 where it may repeat the polling.

Referring still to FIG. 2, if the polling at 204 identified a channel command FIFOs 102 having an AC to be serviced, the decision block 206 sends the process to 208 to determine if any of the R core channels are available. The determination at 208 may be performed by the N:R channel arbiter 108 checking the core channel status array 126 of the FIG. 1 example N-channel DTA/DM memory 100. If the determination at 208 is “NO,” e.g., none of the R CCS flags indicates availability, the process returns to the polling at 204.

In one aspect, the polling at 204 may be performed without making a record of the previous polling at 204 identifying one of the channel command FIFOs 102 having an AC to be serviced. In other words, in this one aspect, if a particular channel command FIFO 102 is detected in successive iterations as having an AC to be serviced, each detection may be viewed as a “first” detection. In one example according to this aspect, multiple AC commands in any given FIFO 102-x may be executed in order, but the RCE 106 may process one AC from that specific FIFO 102-x at any given time. Accordingly, in this particular example of one aspect, if a polling at 204 detects an AC in any FIFO 102-x, but an AC from that same FIFO 102-x that was detected at a previous polling 204 and then assigned to an R-channel is still being processed, the newly detected AC may not be serviced until the in-processing AC has been finished.

In another aspect, the N:R channel arbiter 108 may make a record of detecting a channel command FIFO 102 having an AC to be serviced. Further to this aspect, the N:R channel arbiter 108 may be configured to utilize such a record in instances where a polling at 204 detects two or more channel command FIFO 102 having an AC to be serviced and then, at 208, determines there are not enough available core channels to service all of these channel command FIFOs 102. As previously described, the N:R channel arbiter 108 may be configured to apply, in such instances, any selected arbitration scheme, for example a first-come-first-serve, round-robin or a weighted round-robin scheme.

If the determination at 208 is “YES” the process may go to 210 where the AC detected at 204 in a channel command FIFO 102 is assigned to the available core channel_r detected at 208, then to 212 where the core the CCS flag corresponding to core channel_r is updated to indicate “busy.” In one aspect, while the memory access process servicing the AC is being carried out, the process 200 may return to 204 to perform another polling of the N channel command FIFOs 102.

Referring still to FIG. 2, as shown by functional block 250, to detect when the servicing of the AC is complete, process 200 either receives updating information indicating core channel availability, or actively monitors information indicative of core channel availability. In one aspect, when block 250 detects a core channel_x becoming available it goes to 252 where it updates the CCS-x flag in the core channel status array 126.

It will be understood that although FIG. 2 shows the process 200 as an arrangement of logical blocks, that neither the depicted arrangement nor the order of description are necessarily limiting of the temporal order, or grouping, in which processes embodying one or more of the depicted functional blocks may be performed.

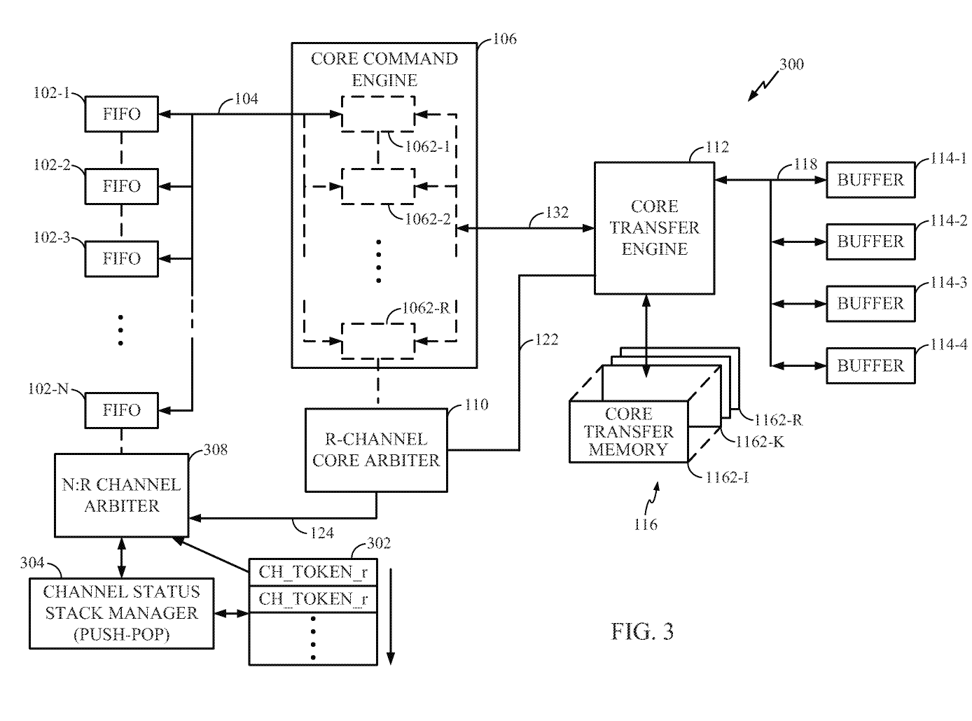

FIG. 3 shows a functional block diagram of one example N-channel DTA/DM memory 300 according to another exemplary embodiment. The FIG. 3 example N-channel DTA/DM memory 300 may be implemented with some of the functional logic blocks shown in the FIG. 1 example N-channel DTA/DM memory 100. To avoid unnecessary repetition of detailed description, functional blocks common to the FIG. 3 example N-channel DTA/DM memory 300 and the FIG. 1 example N-channel DTA/DM memory 100 are labeled with like reference numbers. Portions of previous detailed description may be repeated, where helpful for describing operations of the FIG. 3 embodiment. Further, it will be understood that functional blocks labeled in FIG. 3 with reference numbers not found in FIG. 1 are not necessarily different from the FIG. 1 blocks.

Referring to FIG. 3, the N-channel DTA/DM memory 300 maintains and updates a record of core channel availability with a channel status stack 302 and a stack push-pop manager 304. This is one alternative to the core channel status array 126 of CCS flags shown for the FIG. 1 example N-channel DTA/DM memory 100. In one aspect, the channel status stack 302 and stack push-pop manager 304 may operate as follows: a plurality of R tokens, referenced herein as CH_TOKEN_r, r=1 to R (referenced collectively as CH_TOKEN″) may be provided. When a token CH_TOKEN_r is on the channel status stack 302 this represents that its corresponding r^{th} of the R core channel_r channels is available. At a system initialization event all R of the tokens CH_TOKEN_r are pushed onto the channel status stack 302. When an AC arrives at a channel command FIFO 102 the N:R channel arbiter 308 checks for core channel availability by checking the channel status stack 302. If there are any tokens CH_TOKEN on the core channel status stack 302 the N:R channel arbiter 308 pops the top CH_TOKEN_r off and places it, for example, on a stack for occupied channels (not shown). The N:R channel arbiter 308 then assigns the core channel_r corresponding to the popped CH_TOKEN_r to the channel command FIFO 102 having the detected AC.

In one aspect, upon detection of completion of the task indicated by that AC, the N:R channel arbiter 308 retrieves the CH_TOKEN_r associated with the core channel_r that became available, and pushes that CH_TOKEN_r back onto the core channel status stack 302. It will be understood that the specific means for forming the channel status stack 302 may be in accordance with any of the various means and techniques for establishing push-pop stacks that are known in the art and, therefore, further detailed description is omitted.

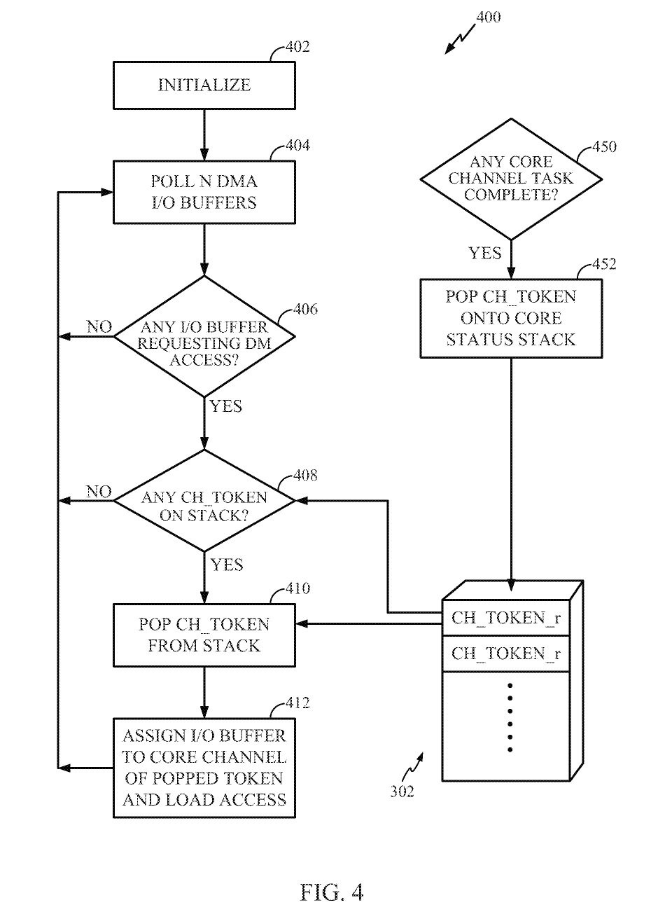

FIG. 4 shows in functional flow diagram one example process 400 of an N-channel DMA of one method according to one or more exemplary embodiments, and will be described in reference to the FIG. 3 example N-channel DTA/DM memory 300. The example process 400 may begin at an initialization 402 where the R tokens CH_TOKEN_r, for r=1 to R may be pushed onto a stack such as the FIG. 3 core channel status stack 302. After the initialization at 402 the process 400 may go to 404, poll the N DMA buffers and then the logical decision block 406 that routes the process depending on whether the polling at 404 identified any channel command FIFOs 102 having an AC to be serviced. The polling 404 and logical decision block 406 may, for example, be performed as previously described for the corresponding blocks 204 and 206 of the FIG. 2 example process 200.

Referring still to FIG. 4, the process 400 then goes to 408, where it checks a core channel status stack, for example, the FIG. 3 core channel status stack 302, to determine if any of the R core channels are available. If the core channel status stack is empty no core channels are available, and the process 400 may return to 404 and repeat its polling of the N channel command FIFOs 102. If block 408 determines the core channel status stack, e.g., 302, is not empty the process 400 may go to 410 where it (e.g. the N:R channel arbiter 308) pops the top core channel access token CH_TOKEN_r, where r is anywhere between 1 and R), off the core channel status stack. The process 400 then goes to 412 where it assigns the channel command FIFO 102 detected at 404 to the core channel_r identified by the popped CH_TOKEN_r and loads the AC into, for example, the RCE 106 for execution as described above and then to 404 to perform another polling of the N channel command FIFOs 102.

Referring to FIG. 4, as shown by functional block 450, the process 400 either receives updating information indicating core channel availability, or actively monitors information indicative of core channel availability. In one aspect, when block 450 detects a core channel_r becoming available it goes to 452 where the N:R channel arbiter 308 retrieves the CH_TOKEN_r associated with the core channel r that became available, and pushes that CH_TOKEN_r back onto the core channel status stack 302.

It will be understood that although FIG. 4 shows the process 400 as an arrangement of logical blocks, that the depicted and described order is not necessarily limiting of the temporal order or grouping in which processes embodying one or more of the depicted functional blocks may be performed.

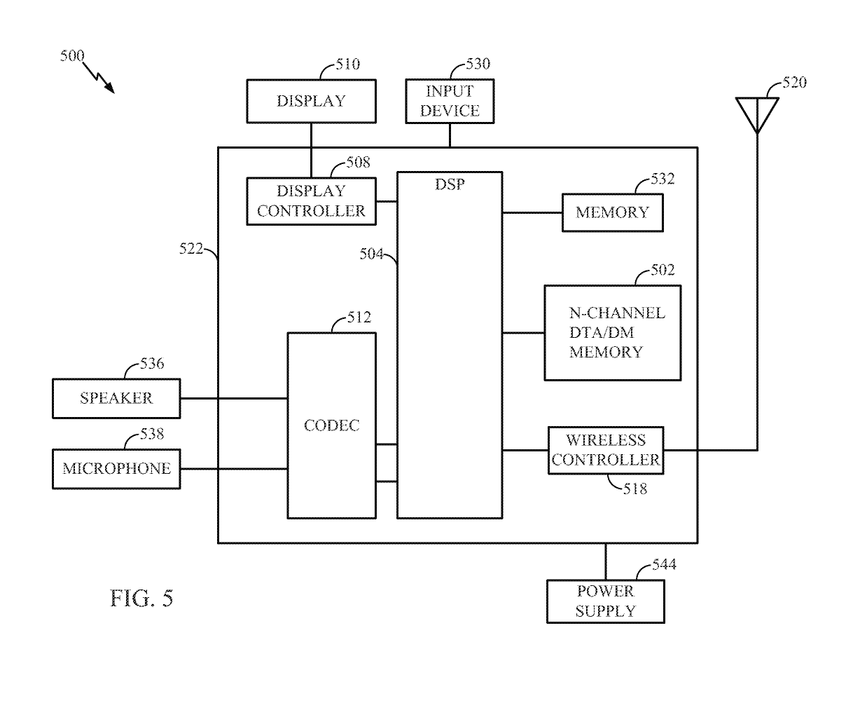

FIG. 5 is a functional block diagram of an electronic device 500, such as a wireless phone according to one or more exemplary embodiments. The device 500 may include an N-channel DTA/DM memory circuit 502 coupled to a processor such as a digital signal processor (DSP) 504 that may be coupled to another memory 532, for example a DRAM. In one illustrative example, the N-channel DTA/DM memory circuit 502 may include the apparatus such the N-channel DMA memory 100 described in reference to FIG. 1, or as one alternative, the N-channel DTA/DM memory 300 as described in reference to FIG. 3 or, in another alternative, any combination thereof.

Referring still to FIG. 5, the electronic device 500 may have a display controller 508 coupled to the DSP 504 and to a display 510. In addition, a coder/decoder (CODEC) 512 may be coupled to the DSP 504, and to a speaker 536 and a microphone 538. A wireless controller 518 may be coupled to the digital signal processor 504 and to a wireless antenna 520. In a particular embodiment, the DSP 504, the display controller 508, the N-channel DTA/DM memory 502, and the CODEC 512, and the wireless controller 518 are included in a system-in-package or system-on-chip (SOC) 522. In a particular embodiment, an input device 530 (e.g., touchpad, keypad, other human command interface) and a power supply 544 are coupled to the system-on-chip system 522. Moreover, as illustrated in FIG. 5, in one aspect the display 510, the input device 530, the speaker 536, the microphone 538, the wireless antenna 520, and the power supply 544 may be external to the SOC 522. However, each may be coupled to one or more components of the SOC 522, for example through an interface or a controller.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for an N-channel DMA storage. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. An N-channel direct memory access (DMA) memory, comprising:
a core memory having R core DMA channels;
N DMA command buffers, N being greater than R, to buffer DMA requests;
a DMA channel status indicator for identifying available core DMA channels among the R core DMA channels; and
an N to R arbiter that detects DMA requests in the DMA command buffers and assigns the detected DMA requests to available core DMA channels.

2. The N-channel DMA memory of claim 1, wherein the N to R arbiter concurrently assigns up to R DMA requests to the R core channels.

3. The N-channel DMA memory of claim 1, wherein the DMA channel status indicator includes a core channel status array storing, for each corresponding one of the R core DMA channels, a value indicating an availability of said corresponding DMA channel.

4. The N-channel DMA memory of claim 3, wherein the core channel status array holds the value as a core channel status flag having a state indicating the corresponding core channel is busy and a state indicated the corresponding core channel is available.

5. The N-channel DMA memory of claim 4, wherein the N to R arbiter is configured to the set, in association with assigning a DMA request to a core channel, the core channel status flag corresponding to said core channel to the value indicating said core channel is busy.

6. The N-channel DMA memory of claim 5, wherein the N-to-R arbiter is to detect a completion of the DMA request and to set the core channel status flag of the core channel associated with the DMA request at the value indicating said core channel is available.

7. The N-channel DMA memory of claim 1, wherein the DMA channel status indicator includes a core channel status stack for holding a stack of up DMA channel identifiers, each DMA channel identifier in the stack identifying an available core DMA channel.

8. The N-channel DMA memory of claim 7, wherein the N to R arbiter determines available DMA channels by determining if any of the DMA channel identifiers are on the core channel status stack.

9. The N-channel DMA memory of claim 8, wherein the N-to-R arbiter is configured to pop from the core channel status stack the DMA channel identifier of the core DMA channel to which a DMA request is assigned.

10. The N-channel DMA memory of claim 9, wherein the N-to-R arbiter is to detect a completion of the DMA request and to push the DMA channel identifier of the core channel associated with the DMA request onto the core channel status stack.

11. A method for N-channel direct memory access (DMA) storage, comprising:
detecting a reception of DMA requests at each of N DMA input/output (I/O) channels;
identifying an availability of core DMA channels among R core DMA channels, R being less than N; and
assigning detected received DMA requests to core DMA channels indentified as available.

12. The method of claim 11, wherein the assigning assigns up to R detected received DMA requests to core DMA channels.

13. The method of claim 11, wherein said identifying availability of core DMA channels includes storing in a status array a value indicating an availability for each of the DMA core channels.

14. The method of claim 13, wherein the storing includes updating a core channel status flag having a state indicating the corresponding core channel is busy and a state indicated the corresponding core channel is available.

15. The method of claim 14, further comprising setting, in association with assigning a DMA request to a core channel, the core channel status flag corresponding to said core channel to the value indicating said core channel is busy.

16. The method of claim 15, further comprising detecting a completion of the DMA request and, associated with said detecting, setting the core channel status flag of the core channel associated with the DMA request at the value indicating said core channel is available.

17. The method of claim 11, wherein identifying available DMA channels among R core DMA channels includes updating a core channel status stack of core DMA channel identifiers, each core DMA channel identifier in the core channel status stack identifying an available core DMA channel.

18. The method of claim 17, wherein the N-to-R arbiter determines available DMA channels by determining if any of the DMA channel identifiers are on the core channel status stack.

19. The method of claim 18, wherein updating the core channel stack includes popping from the core channel status stack the DMA channel identifier of the core DMA channel to which a DMA request is assigned.

20. The method of claim 19, wherein updating the core channel stack includes detecting a completion of the DMA request and pushing the DMA channel identifier of the core channel associated with the DMA request onto the core channel status stack.

21. The method of claim 11, wherein said detecting a reception of DMA requests includes:
buffering received DMA requests at any of N DMA command buffers, each of the I/I buffers associated with a corresponding one of the N DMA I/Os; and
detecting a buffering state of at least one of the N DMA command buffers.

22. The method of claim 21, wherein said assigning includes communicating a DMA request from a DMA command buffer to an R channel DMA core engine associated with the R core DMA channels.

23. An N-channel direct memory access (DMA) memory, comprising:
means for detecting reception of DMA requests at each of N DMA input/outputs;
means for identifying an availability of core DMA channels among R core DMA channels, R being less than N; and
means for assigning detected received DMA requests to core DMA channels indentified as available.

24. The N-channel DMA memory of claim 23, wherein the assigning assigns up to R detected received DMA requests to core DMA channels.

25. The N-channel DMA memory of claim 23, wherein said means for identifying availability of core DMA channels includes means for storing in a status array a value indicating an availability for each of the DMA core channels.

26. The N-channel DMA memory of claim 25, wherein said storing includes holds the value as a core channel status flag having a state indicating the corresponding core channel is busy and a state indicated the corresponding core channel is available.

27. The N-channel DMA memory of claim 26, wherein identifying the availability includes setting, in association with assigning a DMA request to a core channel, the core channel status flag corresponding to said core channel to the value indicating said core channel is busy.

28. The N-channel DMA memory of claim 27, wherein identifying the availability includes detecting a completion of the DMA request and setting the core channel status flag of the core channel associated with the DMA request at the value indicating said core channel is available.

29. The N-channel DMA memory of claim 23, wherein said means for identifying available DMA channels among R core DMA channels includes means for updating a core channel status stack of core DMA channel identifiers, each core DMA channel identifier in the core channel status stack identifying an available core DMA channel.

30. The N-channel DMA memory of claim 29, wherein the N to R arbiter determines available DMA channels by determining if any of the DMA channel identifiers are on the core channel status stack.

31. The N-channel DMA memory of claim 30, wherein updating the core channel stack includes popping from the core channel status stack the DMA channel identifier of the core DMA channel to which a DMA request is assigned.

32. The N-channel DMA memory of claim 31, wherein updating core channel stack includes detecting a completion of the DMA request and pushing the DMA channel identifier of the core channel associated with the DMA request onto the core channel status stack.

33. A method for N-channel direct memory access (DMA) storage, comprising:
step for detecting a reception of DMA requests at each of N DMA input/output (I/O) channels;
step for identifying an availability of core DMA channels among R core DMA channels, R being less than N; and
step for assigning detected received DMA requests to core DMA channels indentified as available.

34. The method of claim 33, wherein said step for identifying availability of core DMA channels includes storing in a status array a value indicating an availability for each of the DMA core channels.

35. The method of claim 33, wherein said step for identifying available DMA channels among R core DMA channels includes step for updating a core channel status stack of core DMA channel identifiers.

36. A computer product having a computer readable medium comprising instructions that, when read and executed by a processor, cause the processor to perform an operation for increasing throughput between a master and slaves, the instructions comprising:
instructions that, when read and executed by a processor, cause the processor to detect a reception of DMA requests at each of N DMA input/output (I/O) channels;
instructions that, when read and executed by a processor, cause the processor to identify an availability of core DMA channels among R core DMA channels, R being less than N; and
instructions that, when read and executed by a processor, cause the processor to assign detected received DMA requests to core DMA channels indentified as available.

37. The computer product of claim 36, wherein the instructions that, when read and executed by a processor, cause the processor to identify an availability of core DMA channels include instructions that, when read and executed by a processor, cause the processor to store in a status array a value indicating an availability for each of the DMA core channels.

38. The computer product of claim 36, wherein the instructions that, when read and executed by a processor, cause the processor to identify an availability of core DMA channels include instructions that, when read and executed by a processor, cause the processor to update a core channel status stack of core DMA channel identifiers, each core DMA channel identifier in the core channel status stack identifying an available core DMA channel.
